(19) United States
(12) Patent Application Publication
(10) Pub. No.: US 2005/0283548 A1
(43) Pub. Date: Dec. 22, 2005

(54) Data extraction from transport refrigeration recording equipment

(75) Inventors: Eliot W. Dudley, Cato, NY (US); Christopher J. Hritcko, Syracuse, NY (US); William C. Silliman, Liverpool, NY (US); Karim Buhagiar, Syracuse, NY (US)

Correspondence Address: WALL MARJAMA & BILINSKI, 101 SOUTH SALINA STREET, SUITE 400, SYRACUSE, NY, 13202, US

(73) Assignee: Carrier Corporation, Syracuse, NY (US)

(21) Appl. No.: 10/870,513

(22) Filed: Jun. 17, 2004

(51) Int. Cl. G06F 13/12

(52) U.S. Cl. 710/62

(57) ABSTRACT

Raw data from the controller of a transport refrigeration system data recorder is selectively downloaded to a portable electronic media containing the necessary software for directing the controller to download such selective data to the portable electronic media and storing it in a format which allows the data to be further downloaded to a personal computer in a form which further allows for use of industry standard graphical user interface procedures without special software in the personal computer.

### BACKGROUND OF THE INVENTION

This invention relates generally to transport refrigeration data recording equipment and, more particularly, to a method and apparatus for extracting selected recorded data therefrom.

In the control and monitoring of transport refrigeration systems, it is important to maintain a system for monitoring, on a continuous basis, various system conditions such as temperature, humidity and the like, as well as time and dates of certain events that occur. This data, which is recorded in sensor data logs and event data logs in a data recording device is used to control the system and to provide a history that can be useful in monitoring the condition of the goods contained in the refrigerated vehicle.

Typically, the data in a data recorder is transferred to a computer for processing by a technician. One method by which this was done was by connecting laptop computers or custom data extraction computers to the data recorders via a serial data communication. This was slow and inconvenient, and required highly specialized software for the recipient IBM-PC compatible computer to read the data from the data recorder. Because of the many different types of PCs and operating systems, this was difficult to support and maintain.

Another approach was to write the data from the data recorder controller to a personal computer (PC) card in a propriety format. There were two problems with this approach. First, the application code for causing the controller to write data to the card was contained within the controller. Accordingly, if changes were made to the data extraction code, the application code would need to be upgraded, which was inconvenient and expensive. Secondly, there was still a problem of needing to require specialized software for the IBM-PC compatible computer as discussed hereinabove.

Another problem facing the industry is that with the present approaches there are a very limited number of data extractions that can be made to an individual PC card. That is, it is desirable to use a single PC card to download recorded data from a number of different transport refrigeration units. The present systems allow only “all data” downloads, and only a very limited number of downloads can be made on a single card.

### SUMMARY OF THE INVENTION

Briefly, in accordance with one aspect of the invention, a portable electronic media card (PC card) was embedded therein, the application software for communicating with the transport refrigeration controller for the purpose of directing the controller to download selected data to the card. In this way, the software can be easily upgraded by upgrading the software in the card, and the software within the controller need not be modified.

In accordance with another aspect of the invention, the recorded data that is downloaded into the PC card is stored in a format which then allows the PC card to be connected to a computer such that the recorded data can be moved to the PC using industry standard graphical user interface procedures, with no special PC software being needed.

By another aspect of the invention, rather than downloading “all data” from the controller as is now required, it is possible to download selective portions thereof, such that selective data from more individual transport refrigeration units can be downloaded into a single card. Further, this data download procedure can be accomplished in a fraction of the time that it has taken with serial data communications.

In the drawings as hereinafter described, a preferred embodiment is depicted; however, various other modifications and alternative constructions can be made thereto without departing from the true spirit and scope of the invention.

### BRIEF DESCRIPTION OF THE DRAWINGS

FIG. 1 is a schematic illustration of a transport refrigeration system data recording system with download capability as provided in accordance with an embodiment of the present invention.

FIG. 2 is a schematic illustration of a PC card and the functional software embedded therein in accordance with an embodiment of the present invention.

FIG. 3 is a flow diagram illustrating the method of downloading recorded data in accordance with an embodiment of the present invention.

### DESCRIPTION OF THE PREFERRED EMBODIMENT

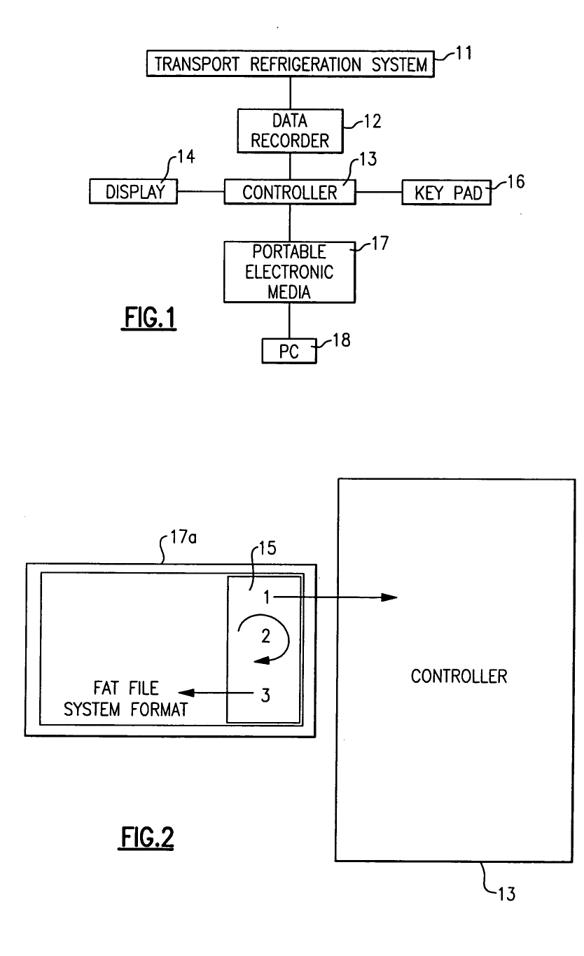

Referring now to FIG. 1, there is shown schematically, a transport refrigeration system 11, which may of be various types such as a truck, trailer, or a refrigerated container, that is designed to maintain a temperature range within the vehicle for purposes preserving its contents. Such a system includes a closed circuit refrigeration system that includes, in serial flow relationship a compressor, a condenser, an expander and an evaporator.

Such a refrigeration system includes a number of sensors for sensing, on a continuous basis, the various parameters indicative of the condition within the vehicle, such as temperature, humidity and the like. The sensed data, along with the associated times and dates are recorded in data logs by way of a data recorder 12. In addition, the data recorder 12, by way of event data logs, records the dates and times of the occurrence of certain operating events such as alarm states or control mode changes. Such recorded data is considered as raw data, which is used by an operator/technician for the purposes of controlling the systems and monitoring the performance thereof.

The raw data which is recorded by the data recorder 12 is stored in a controller 13 having a display 14 in which the recorded data can be selectively displayed. Selection of particular data or data sets is accomplished by way of a keypad 16 connected to the controller 13.

The recorded raw data in a controller 13 can be selectively viewed on a display 14 by manipulation of a keypad 16 by an owner or operator of the vehicle at any time. However, for purposes of analysis of the data on a longer term basis, such as over a thirty/sixty/ninety day period, by a technician for the purpose of analyzing the data to determine performance of the system, it is necessary to periodically download the data and to analyze that data by the use of a personal computer. This is accomplished by way of a portable electronic media 17 which can be inserted into the controller 13 to extract the raw data from the controller 13. The portable electronic media 17 can then be interconnected to a personal computer 18 by way of the bus architecture to then allow a technician to selectively display the data for purpose of analysis.

A common approach is for a technician to travel to a site or sites of a number of transport refrigeration systems units where a single portable electronic media 17 can be inserted into the respective controller of those systems in order to download the recorded data therefrom. For that reason, it is important that the technician be allowed to select the particular data of interest from the controller and to rapidly extract that selected data therefrom. It is also important that the technician be able to rapidly download that data from the portable electronic media 17 to the personal computer 18.

In accordance with a preferred embodiment of the invention, the software for selecting and extracting the data from the controller 13, for storing it in a particular format in the portable electronic media 17, and for allowing it to be downloaded into a personal computer 18 in a useful form and format, is all contained within the portable electronic media 17, which, for purposes of description, will be referred to as a PC card 17a, which is one form of a portable electronic media that can be used for these purposes.

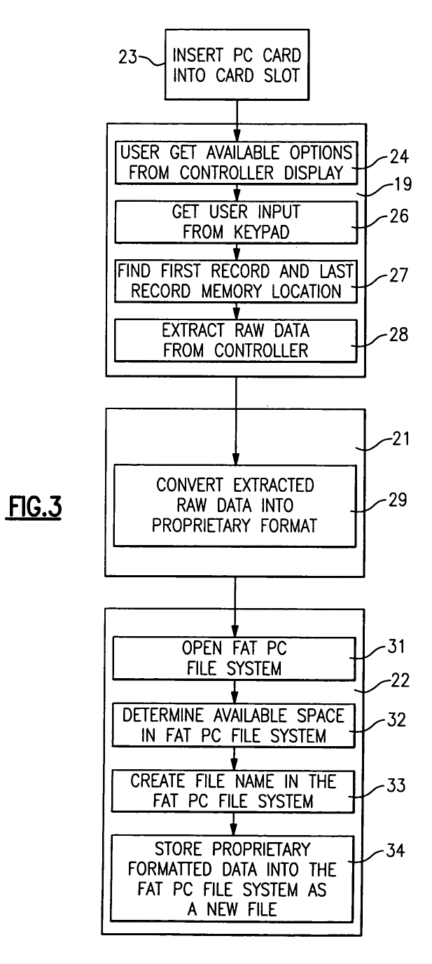

As will be seen in FIG. 2, the PC card 17a interfaces with the controller 13, and its installed software is schematically shown at block 15. PC card 17a is formatted in a FAT File System Format, which is a publicly available format from Microsoft.

Installed software 15 is designed to perform three separate functions as indicated by the numbers 1, 2 & 3. Each of these three functions is further defined in the respective functional blocks 19, 21 and 22. The installed software 15 interfaces with the controller 13 to manage other activities that take place within the controller 13, such as those of the display 14 and keypad 16, to extract selected recorded data from the controller 13. In functional block 21, the installed software 15 converts the extracted raw data into a proprietary format and, in the process, ensures that the raw data is valid and verifies the validity of the data. In functional block 22, the installed software 15 interfaces with the PC card and the FAT file system to install the extracted data into the PC card 17a, while ensuring that the data is saved to the card such that it is compatible with a FAT file.

Referring now to FIG. 3, the steps taken in the process of extracting data from the data recorder are shown. At block 23, the user inserts the PC card 17a containing the installed software into the controller card slot. At block 24, the installed software 15 residing on the PC card 17a commences the execution by using the display 14 to show the user the available options. The user can then select how many days of records are to be extracted from the controller 13. For example, the possible selections typically include “30 days”, “60 days”, “90 days” or “all”.

In block 26, the user is able to select from the various options by scrolling through the available options using the up/down arrow of the unit keypad 16. To execute the desired selection, the user presses “enter” on the keypad 16.

In block 27, the installed software 15 within the PC card 17a causes the controller 13 to scan through all of the records in its recorded data to find those records that fall within the option selected. For example, if the user selected 30 days, the software scans all of the records from the last 30 days. Once all of the records to be extracted are identified, the controller ID number is retrieved and used to create the name of the file network containing the data records to be extracted.

In block 28, the installed software 15 causes the controller 13 to compute the total size of the records falling within the selected option and compares that size to the space available in the PC card 17a. This check is performed to ensure that the records to be extracted will fit into the PC card 17a. If the space available is sufficient, then the installed software 15 causes the controller 13 to extract the selected records. In block 29, the selected records containing the extracted raw data are then converted into a proprietary format described hereinabove. In functional box 22, wherein the installed software 15 interfaces with the PC card 17a and the FAT file system, FAT PC file system is opened in block 31 and in block 32, the available space within the FAT PC file system is determined. A file name is created in the FAT PC file system as shown in block 32 and, as shown in block 34, the proprietary formatted data is stored in the FAT PC file system as a new file.

It will thus be seen that each of the steps shown in blocks 24-32 are caused to occur by the software 16 installed in the PC card 17a, with the controller 13 performing the various functions.

The PC card 17a can then be installed into an IBM-PC, and the stored data in the PC card can be retrieved and used for analysis by the operator of the PC.

It should be recognized that, while the present invention has been described in terms of use with a PC card, other types of portable electronic media may be used such as, for example, USB drives.

While the present invention has been particularly shown and described with reference to preferred and alternate embodiments as illustrated in the drawings, it will be understood by one skilled in the art the various changes and detail may be effected therein without departing from the true spirit and scope of the invention as defined by the claims.

1. A method of extracting recorded data from a data recorder of a transport refrigeration system, comprising the steps of:
providing a controller for operating said data recorder and for storing recorded data therefrom;
providing a portable electronic media capable of being electronically connected to said controller and to a computer;
installing application software into said portable electronic media;
uploading a portion of said applicable software to said controller for directing said controller to download data therefrom;
selecting certain data of interest in said recorded data; and
using said uploaded software portion in said controller, directing said controller to download said selected data to said portable electronic media and storing it therein.

2. A method as set forth in claim 1 and including a keypad operatively connected to said controller and further wherein said step of selecting certain data of interest is accomplished with said keypad.

3. A method as set forth in claim 1 wherein said steps of downloading and storing selected data to said portable electronic media is accomplished in a file allocation table (FAT) format.

4. A method as set forth in claim 1 wherein said portable electronic media comprises a personal computer card.

5. A method as set forth in claim 4 wherein said personal computer card is standardized in accordance with the Personal Computer Memory International Association (PCMCIA) standards.

6. A method as set forth in claim 1 wherein said portable electronic media is a USB drive.

7. A method as set forth in claim 1 and including an additional step of interconnecting said portable electronic media to a personal computer and downloading said selected data to said computer.

8. A method as set forth in claim 7 wherein said downloaded selected data is in a format which allows the data to be further selected by said computer with drag-and-drop procedures without special software residing in said computer.
